(19) United States
(12) Patent Application Publication
(10) Pub. No.: US 2017/0069078 A1
(43) Pub. Date: Mar. 9, 2017

(54) METHOD AND APPARATUS FOR WEB CONVERTING VISION INSPECTION SYSTEM SETUP

(71) Applicant: Delta Industrial Services, Inc., Minneapolis, MN (US)

(72) Inventors: Evan Schiebout, Oak Grove, MN (US); Robert Hattling, Elk River, MN (US)

(21) Appl. No.: 15/260,616

(22) Filed: Sep. 9, 2016

Related U.S. Application Data
(60) Provisional application No. 62/216,034, filed on Sep. 9, 2015.

(51) Int. Cl. G06T 7/00; B65H 20/02; B65H 43/08; G01N 21/89

(52) U.S. Cl. CPC G06T 7/0004; G01N 21/8901; B65H 20/02; B65H 43/08; G06T 2207/30108; G01N 2021/8909

(57) ABSTRACT

Techniques are provided for setting up a vision inspection system from a human-machine interface of a web converting system. In an example, a web converting system can include a web converting machine configured to make a first part, a vision inspection system configured to capture an image of the first part and to analyze the image according to one or more measurement tools, and a human machine interface (HMI) configured to interface with the web converting machine and with the vision inspection system, to display status information of the web converting machine and the vision inspection system, to receive one or more inputs to select, place, size and orient the one or more measurement tools, and to transform the one or more inputs for reception by the vision inspection system.

### PRIORITY AND RELATED APPLICATIONS

This application claims the benefit of priority under 35 U.S.C. §119(e) of Schiebout et al., U.S. Provisional Patent Application Ser. No. 62/216,034, entitled “METHOD AND APPARATUS FOR VISION INSPECTION SYSTEM SETUP,” filed on Sep. 9, 2015 (Attorney Docket No. 2285.024PRV), which is hereby incorporated by reference herein in its entirety.

### BACKGROUND

There are various automated systems and methods for producing product. By way of example, automated web converting systems may process material from different rolls of material to form products. The continuous rolls of material can be fed as “webs” through web processing components to form a new product that may be an intermediate or final product. Converting processes may include coating, laminating, printing, die cutting, slitting, and the like. In addition to the mechanics of the machine for moving the web(s) through the machine, a web converting system can include various sensors and sensor systems to monitor and control the operation of the converting system and to inspect products at one or more points along the web paths. One such sensor system that can be employed to inspect products is a vision inspection system.

In general, a vison inspection system can collect an image of one or more parts as the converting system is running, can compare if certain aspects of the part are within acceptable thresholds based on the image, and can provide an indication of the comparisons. In certain examples, the indication can be provided to a machine controller, a human machine interface, a reject system or combination thereof. Prior to placing the machine in production, the vison inspection system can be configured so that the processing of an image of one or more parts that can be produced by the converting system can be done reliably. Such configuration typically can require a technician that is very knowledgeable with the vision inspection system, the machine controller programming and operation, and the reject system programming and operation. In addition, configuring the vison system to perform reliably for an individual part can take a qualified vision system technician several hours.

As web converting equipment has evolved, some manufacturers can now produce very modular and configurable equipment that can mechanically be reconfigured for a new part in very little time, for example on the order of a few minutes. Unfortunately, vision inspection system configuration for a part that has not been produced on a machine or for an existing part that has been dimensionally reconfigured can result in lost production time.

### OVERVIEW

Techniques are provided for setting up a vision inspection system from a human-machine interface of a web converting system. In an example, a web converting system can include a web converting machine configured to make a first part, a vision inspection system configured to capture an image of the first part and to analyze the image according to one or more measurement tools, and a human machine interface (HMI) configured to interface with the web converting machine and with the vision inspection system, to display status information of the web converting machine and the vision inspection system, to receive one or more inputs to select, place, size and orient the one or more measurement tools, and to transform the one or more inputs for reception by the vision inspection system.

This summary is intended to provide an overview of subject matter of the present patent application. It is not intended to provide an exclusive or exhaustive explanation of the invention. The detailed description is included to provide further information about the present subject matter.

### BRIEF DESCRIPTION OF THE DRAWINGS

FIG. 1 illustrates generally an example web converting system 100

FIGS. 2A and 2B illustrate generally camera images with several example vison inspection tools overlying the image.

FIG. 3 illustrates generally an example HMI vison inspection system display for an HMI of a converting machine.

FIG. 4 illustrates general a block diagram of example an example architecture for providing a simplified vision system setup of a complex vision inspection system.

FIG. 5 illustrates generally an HMI vision inspection system main setup screen.

FIG. 6 illustrates generally an example HMI vision inspection system calibration setup screen.

FIG. 7 illustrates generally an example HMI pattern find vision setup screen for assisting in detecting and providing an anchor for measurements of each of the vision tools.

FIG. 8 illustrates generally an example operator interface vision setup tool 711 that can be used to setup the first and second pattern find boxes to define the sub-areas within the captured camera image.

FIG. 9 illustrates generally an example HMI measurement tools setup screen.

FIG. 10 illustrates generally a flowchart of an example method for setting up vision system tools using a web converting system HMI environment.

FIGS. 11-13 illustrate generally a programmable tool of an example vision inspection system.

### DETAILED DESCRIPTION

The present inventor(s) have recognized methods and apparatus for allowing quick vison inspection system configuration such that a vision inspection system configuration for a new part, or a dimensionally reconfigured part, can be accomplished in minutes and can be accomplished by, in most examples, a machine operator trained on the vison tools preconfigured for a particular machine. Using machine operators for vison inspection system configuration can often be much less expensive, in terms of both monetary cost and time, than using a fully qualified vision inspection system technician that may or may not be locally available.

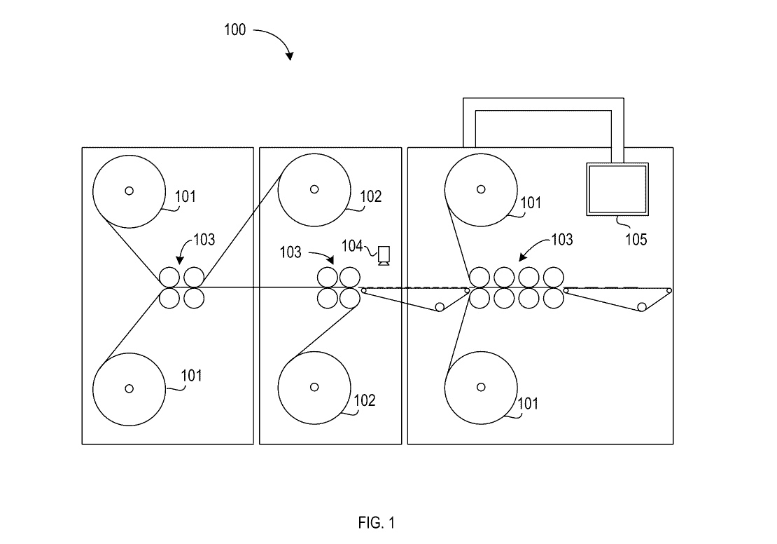

FIG. 1 illustrates generally an example web converting system 100 including one or more unwinds 101, one or more rewinds 102, one or more processing stations 103, a vision inspection system 104, a machine controller(not shown) and a human-machine interface (HMI) 105. The one or more processing stations can include, but are not limited to, a die station, a nip station, a sealer station, a part placement station, an island placement station, a packager, a reject station, part transfer conveyors, or combinations thereof. Servo motors or other actuators can be used to drive the various stations. In certain examples, the machine controller can trigger the vision inspection system 104 to capture and analyze an image. In certain examples, the machine controller can trigger the vision inspection system 104 each cycle of the machine where a cycle typically, but not necessarily, represents the time, or distance the web moves, to produce one part in one lane of the web converting system 100. In some examples, the web converting system 100 can have multiple lanes across the web width of the machine such that multiple parts are actually produced by the machine in one cycle. In some examples, the vison inspection system 104 can be designed such that one camera is tasked with capturing each part on one lane. In some examples, the vison inspection system 104 can be designed such that one camera is tasked with capturing each part on more than one lane. In some examples, the vison inspection system 104 can be designed such that more than one camera is tasked with capturing each part on a single lane. It is understood that the web path of FIG. 1 is an example web path and that other web path designs are possible without departing from the present subject matter. The HMI 105 is used to monitor the activities of the web converting system 100 and provides a user interface to modify parameters of the system including parameters that affect the operation of the one or more unwinds 101, rewinds 102 and processing stations 103, and parameters that affect operation of the vision inspection system 104. In addition to the issues identified above in the background, convention techniques require a separate interface to configure the vision inspection system 104. As illustrated in FIG. 1, however, the new techniques of the present subject matter allow for a seamless integration of both the monitoring of the vision inspection system 104 during operation of the web converting system 100 and the configuration of the vision inspection system 104 within a single HMI 105.

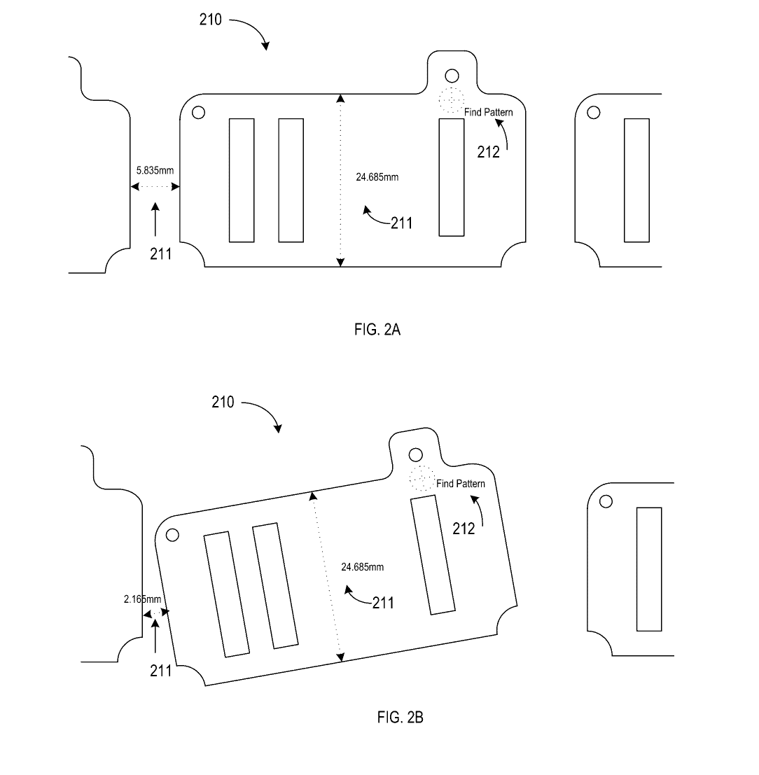

FIG. 2A illustrates generally an example camera image 210 with several vison inspection tools 211, 212 overlying the image. In some examples, the production part 213 can be represented by contrast between the part and the background. Upon capturing the image, the vison inspection system can process the image 210 along with the one or more vison inspection tools 211, 212. In an example, the processing for one of the illustrated inspection tools can include identifying two edges separating, for example, a light colored part and a darker background within the box identifying the tool. In the illustrated image of FIGS. 2A and 2B, the vision inspections tools 211, 212 can include two distance measurement tools 211 and a pattern recognition or anchor tool 212.

For distance measurement vision tools 211, upon identifying the two contrast edges within the tool limits or box, the vison inspection system can use a count of the pixels separating two contrast edges to measure the distance between the two edges and provide a measured distance. The vison inspection system can then compare the measured distance to predetermined nominal distance to provide an error measurement of the production part. The error measurement can be compared to a predetermined tolerance for an acceptable part. Depending on the result of the tolerance comparison, the vison inspection system can provide an indication that the tool evaluated as acceptable or not acceptable.

In some examples, the HMI can communicate with the vision inspection system and can display the image 210 of FIG. 2A or 2B as the converting system runs. In some examples, as each vison tool is evaluated, the color of the tool 211, 212 can provide an indication of whether the vison tool evaluated as acceptable (e.g., green) or unacceptable (e.g., red). An example vision inspection system can include additional vision tools that can measure other qualities besides the distance between two edges. In certain examples, the anchor tool 212 cab be configured to identify the location and orientation of the part within the image 210. In certain examples, upon capturing an image, the vision inspection system uses the anchor tool 212 to identify a certain aspect or pattern of the part within the image and to anchor other tools to the identified location and orientation. This can be very useful on web converting systems where the parts, the orientation of the parts, or both the part and their orientation can drift within the image captured by the vision inspection system. For example, the image of FIG. 2B illustrates a part with a substantially different location and orientation within the camera image 210. Even with the substantial difference, the vision system can anchor other evaluation tools the location and orientation identified by the anchor tool 212 and evaluate each respective tool measurement 211 or aspect.

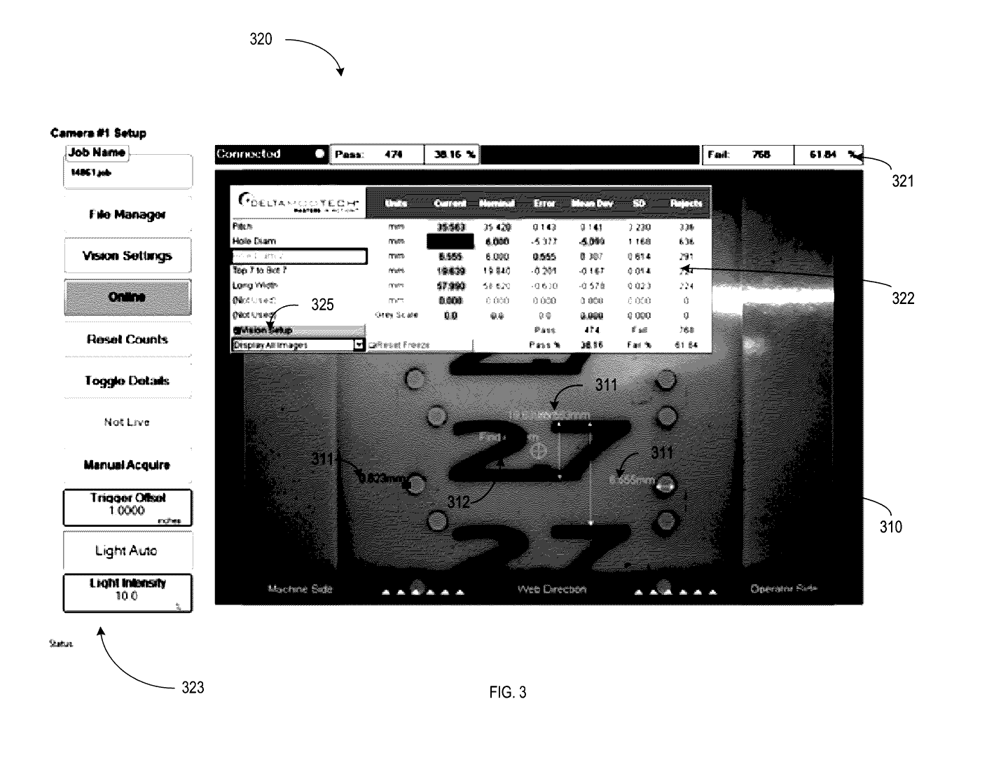

FIG. 3 illustrates generally an HMI vison inspection system display 320 for an HMI of a converting machine. The inspection system display 320 can allow an operator to set-up and monitor at least a portion of a vison inspection system. The inspection system display 320 can include a camera image and tool display area 324 including a camera image 310 and a display of configured vision tools overlaying the image, a general vision inspection status display area 321, a detailed vision inspection status display area 322, and user interface area 323 for adjusting parameters and actions associated with the vision inspection system. In certain examples, a converting machine or system can include several cameras as part of the vision inspection system and each camera can be setup independently. The camera image and tool display area 324 can display a camera image 310 and one or more tools 311, 312 that indicate how the tool recognized its associated measurement and, in certain examples, the value of the measurement. In certain examples, the color of the one or more tools 311, 312 can illustrate whether the tool evaluated within tolerance of a predetermined nominal value or not. For example, if the tool evaluated within a tolerance of the nominal measurement, the tool can display as green while a measurement outside the tolerance can display as red. In certain examples, the camera image display can include prompts indicating the direction of the web and the orientation of the part with respect to the machine or the typical operator location.

The general vision inspection status display area 321 can provide information on overall vision inspection system pass and fail results. In some examples, the overall results can be displayed as counts. In some examples, the overall results can be displayed as a percentage of all parts evaluated by the vision inspection system. In some examples, a connection status between the HMI and the vision system can be displayed. In certain examples, the overall pass/fail result for the currently displayed camera image can be displayed using text color or both text and color.

The detailed vision inspection status display area 322 can provide inspection results and parameters associated with each measurement tool. In certain examples, information for all the vision tools available in the vision inspection system and associated with the specific web converting machine are displayed whether the vision tool is enabled or not. Parameters and values associated with the vision tools and displayed in the detailed vision inspection status display area can include, but are not limited to, measurement units, current measured value evaluated by the vision inspection system, nominal measurement value, error between the current measurement value and the current measured value, historical mean deviation of the measured value from the nominal value, standard deviation, and count of the number of rejects measured by the particular vision tool. In certain examples, the detailed vision inspection status display area can also display overall pass fail statistics. In certain examples, the detailed vision inspection status display area can include operator interface tools for freezing and resetting a frozen image. In certain examples, the detailed vision inspection status display area can adjust the number of images displayed at one time.

In certain examples, the user interface area 323 for adjusting parameters and actions associated with the vision inspection system can include status information associated with the job being run on the converting system. In certain examples, the user interface area for adjusting parameters and actions associated with the vision inspection system can include user interface tools managing vision system setup files that can include all the parameters associated with vision inspection if a certain part or series of parts. In certain examples, the user interface area for adjusting parameters and actions associated with the vision inspection system can include on or more of a button for editing other vision settings, a button for activating and displaying the online status of the vision system, a button to reset various counts associated with the vision inspections system, a status display indicating whether the current image is a live image from the camera, a button to manually capture an image from the camera, a button to adjust and display the camera trigger offset, a button to enable and disable lighting associated with the camera, and a button to adjust and display a lighting intensity level.

In certain examples, the trigger offset can allow an operator to adjust when the camera is triggered. Such adjustment allows the operator to adjust, in the web direction, the position of the part in the field of view of the camera such that, for example, the image of the part can be centered in the field of view of the camera at the time the image is acquired by the camera. In certain examples, lighting associated with the camera can be harsh and distracting. The button for enabling and disabling the lighting can allow the machine controller to control the intensity of the light through out machine operation. For example, under automatic control, the controller may turn on the light while the machine is moving and turnoff the light when the machine is stopped. In some examples, under automatic control, the controller may adjust the intensity of the light with the speed of the machine.

In certain examples, the detailed vision inspection status display area 322 can include an operator interface element 325 to allow setup of the vision tools available on the particular converting machine. The next sections discuss the vision setup techniques available to the machine operator that can allow for quicker machine turnover when a new or reconfigured part is to be run on the converting system.

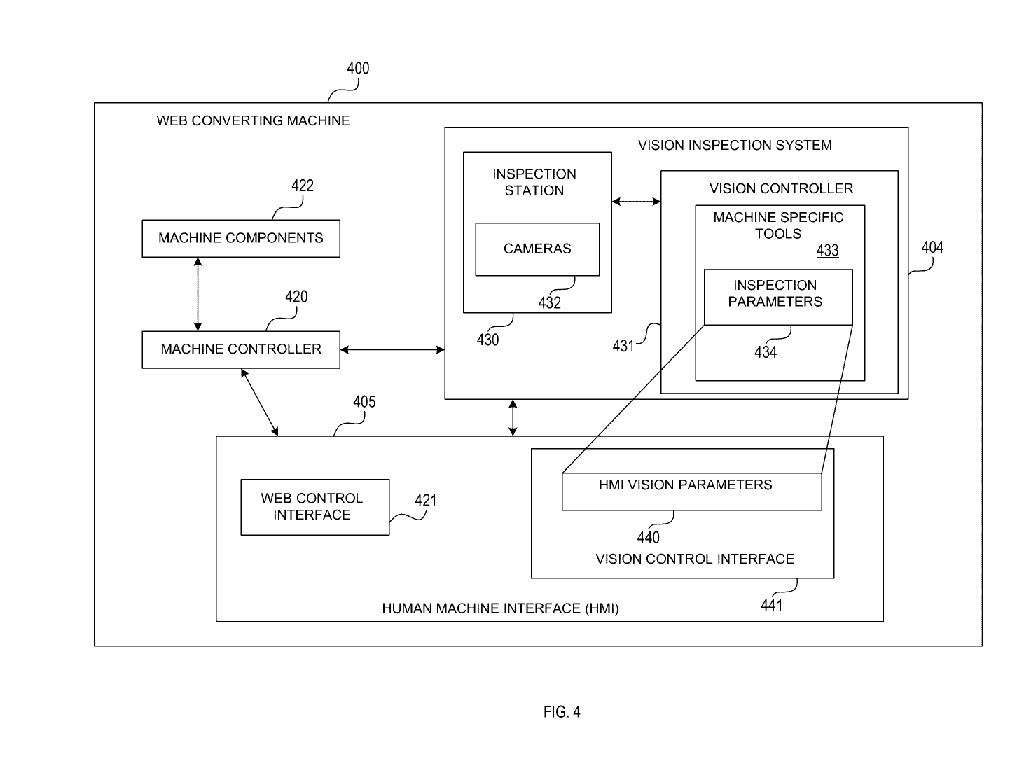

FIG. 4 illustrates general a block diagram of an example web converting system for providing a simplified vision system setup of a complex vision inspection system. The example web converting system can include a web converting machine 400. The web converting machine 400 can include a machine controller 420, a human machine interface (HMI) 405 and a vision inspection system 404. Each of the machine controller 420, HMI 405 and a vision inspection system 404 can communicate over one or more communication links. The machine controller 420 can monitor a number of inputs, including inputs from the HMI 405 and vision inspection system 404, and can control various machine components 422 of the web converting machine such as, but not limited to, motors, actuators, tension controls, quality systems, reject systems, etc.

The vision inspection system 404, in general, is tasked with collecting images associated with the web converting machine operation and processing the images with certain measurement tools to evaluate whether those measurements are within an acceptable tolerance. The vison inspection system 404 can communicate the evaluation results to the machine controller 420 and the HMI 405. In certain examples, the vision inspection system 404 can include an inspection station 430 and a vision controller 431. An inspection station 430 can include one or more cameras 432 for capturing images. The vision controller 431 can receive each image and process or evaluate the image according to whatever machine specific vision tools 433 have been setup in the vision controller 431.

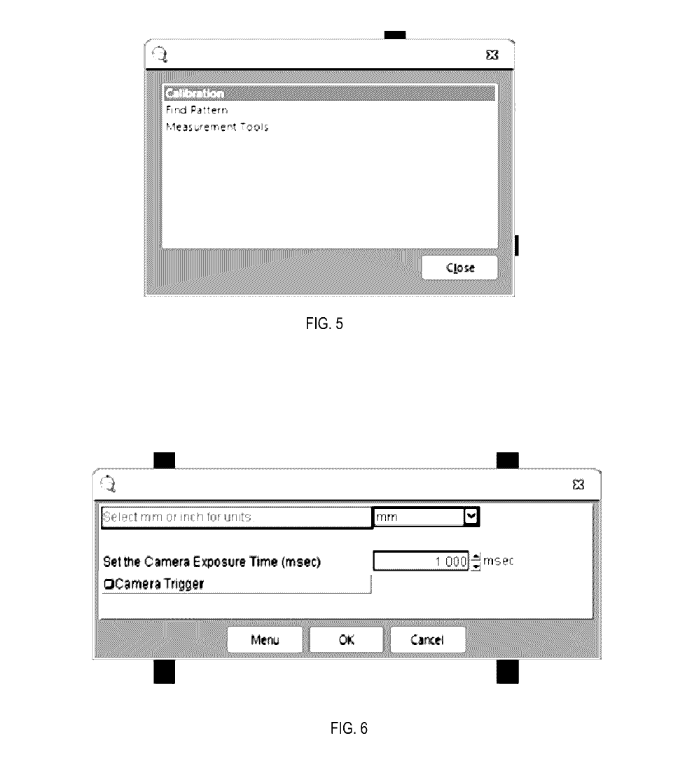

The HMI 405 can provide operator displays and control inputs. Such displays and inputs can allow the operator to evaluate the status of the machine and to make adjustments based on the status and operational goals of the machine such as via a web control interface 421. In certain examples, the HMI can allow an interface for modifying parameters of the unwinds, the rewinds, the processing stations and the vision inspection system. Parameters associated with the unwinds, the rewinds and the processing station can include tension set points, maximum rewind diameter, gear ratios, registration set points, or combinations thereof. In certain examples of the present subject matter, the HMI 405 can present a simplified vision system setup environment that can allow certain vision system parameters 440 associated with inspection parameters 434 of machine specific tools 433 to be set-up and modified by an operator via a vision control interface 441 of the HMI 405. Typically, vision parameters and tools are setup completely by a technician specially trained on the vision inspection system using an interface separate from the web converting system and specifically designed for the vision inspection system. Once set-up, the vision inspection system would not be modified until a technician had a further opportunity to make adjustments. In certain examples, the vison control interface 441 of the HMI 405 can transform the complex array of vision tools available in the vision inspection system 404 to a simplified vison set-up interface format that an operator or other machine associated personnel can use to modify machine specific vison tools 433 for new production parts or re-dimensioned parts without the expense and delay associated with contacting, scheduling and waiting for a specially trained technician. In certain examples, the machine specific vision tools 434 are a subset of the available vision tools available with the vision inspection system 404 and are partially set-up within the vision controller 431 by a specialized vision technician. FIGS. 5-9 discuss particular examples of an example vision control interface.

FIG. 5 illustrates generally an HMI vision inspection system main setup screen. In certain examples, the HMI vision inspection system main setup screen can include buttons to navigate to additional vision setup screens including but not limited to, a calibration screen, a pattern definition screen and a screen for setting up individual vision tools.

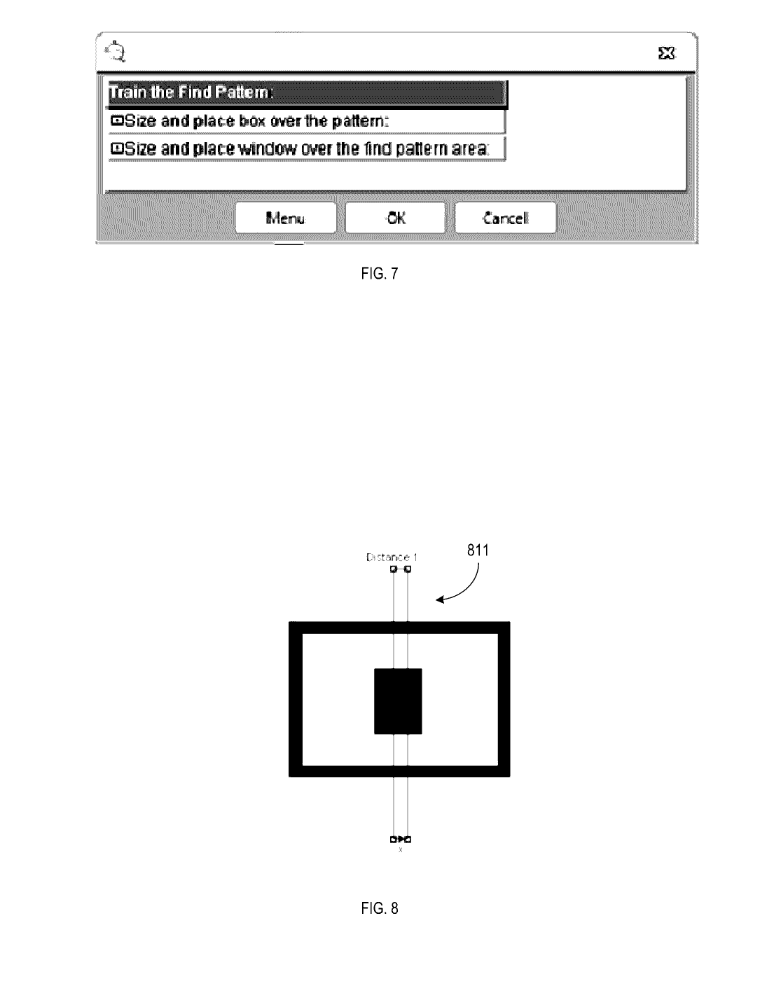

FIG. 6 illustrates generally an example HMI vision inspection system calibration setup screen. In certain examples, the HMI vision inspection system calibration setup screen can include operator interface tools to enter or adjust certain overall vison parameters including, but not limited to, distance measurement units, camera exposure time, and the nominal camera trigger point. In certain examples, the camera exposure time can be entered in units of milliseconds (msec). In some examples, the camera trigger point is entered as a unit of distance in a range specific to the part(s) being produce on the converting machine. For example, if the web repeat length of a part is X inches, the camera trigger point can be entered as a number between 0 and X inches.

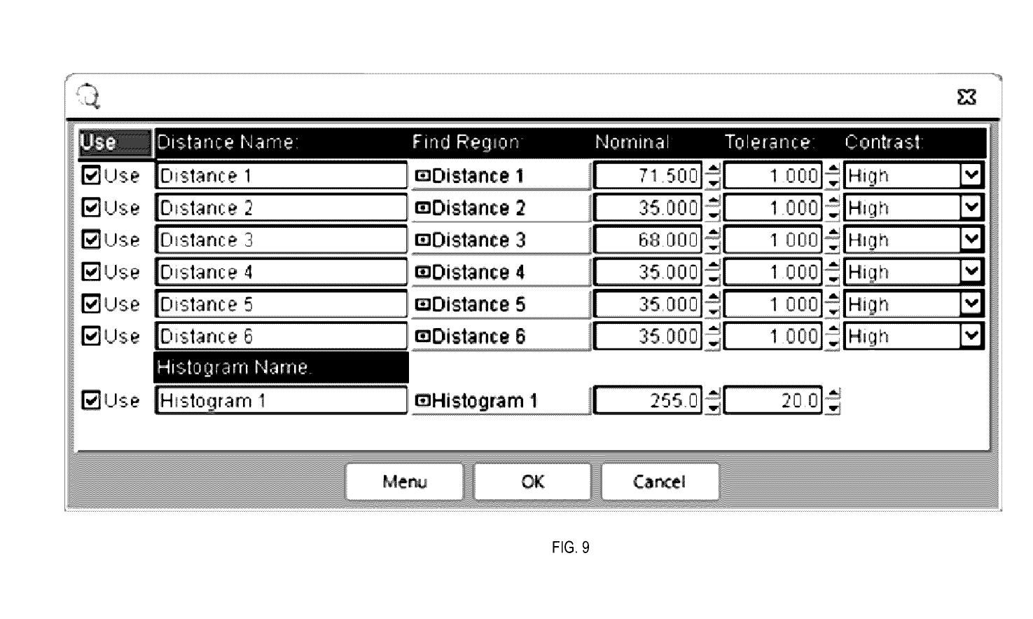

FIG. 7 illustrates generally an example HMI pattern find vision setup screen for assisting in detecting and providing an anchor for measurements of each of the vision tools. In certain systems, the vision system upon acquiring an image first processes the image to detect a pattern that should be present on all acceptable parts. To assist in that processing, the HMI pattern find vision setup screen provides two buttons that allows a machine operator to set up two image sub-areas that can limit the amount of image data processed for finding the anchor pattern. The first HMI button allows the operator to place a first box that encloses the distinguishing part pattern. The second HMI button allows the operator to place a second box that limits the area within the overall image where the pattern should be found. The second box is typically larger than the first and can allow the vison system to find the pattern even if the part moves or rotates within the field of view of the camera. Once the vision inspection system finds the pattern, the other vision tools are referenced to the location and orientation of the detected pattern. In certain inspections, if the part is so misplaced within the camera field of view, the part inspection can fail because the vision system is not able to locate the anchor pattern.

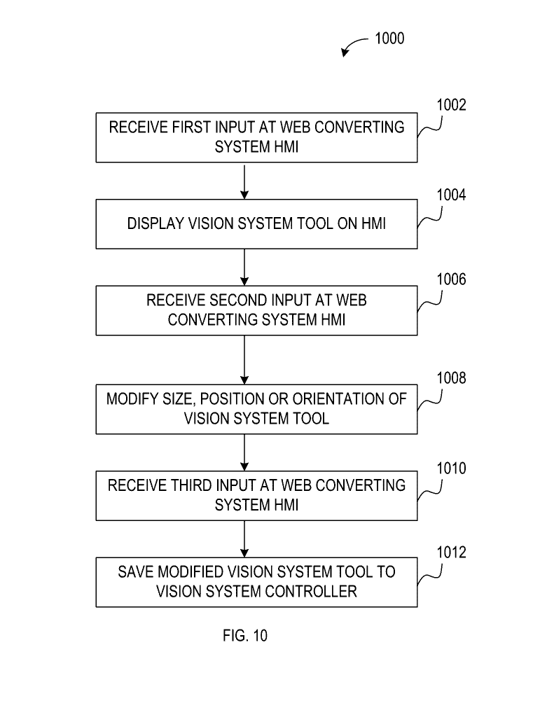

FIG. 8 illustrates generally an example operator interface vision setup tool 811 that can be used to setup the first and second pattern find boxes to define the sub-areas within the captured camera image. In certain examples, upon initiating a tool setup, such as a pattern find tool or some other measurement tool, the HMI computer or processors can display a default vision setup tool. The operator can then use a mouse or a touch screen to move, orient and size the tool for the particular set-up. For a first box of the pattern find setup, the operator can move, orient and size the tool to enclose the desired pattern. For the second box of the pattern find setup, the operator can move, orient and size the tool to limit the image area in which the pattern should typically be found within the overall image. Reference will again be made to FIG. 8 and the vision setup tool in the sections that follow and that discuss other vision tools. Upon the user finalizing the placement, size or orientation of the vision setup tool 811, the HMI can transform the placement, size and orientation relative to the real world image from the camera to provide parameters to the vision system for successful and robust evaluation of the tool during operation of the web converting machine.

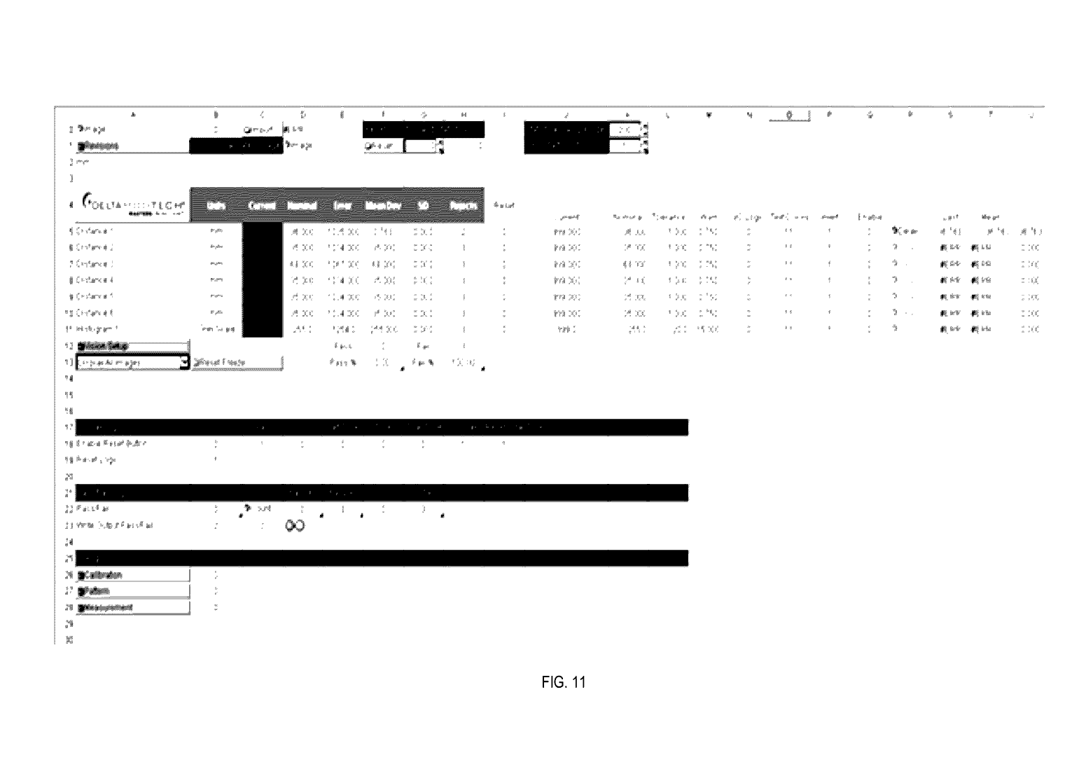

FIG. 9 illustrates generally an example HMI measurement tools setup screen. In certain examples, the HMI measurement tools setup screen can include a number of vision measurement tools displayed in a matrix in which each cell can be associated with a parameter of a measurement tool or an operator control to setup the measurement tool with reference to the camera image and pattern. In some examples, the vision tools can include tools for measuring distances between contrast transitions and tools to measure the shading or histogram of an area. In certain examples, the tools are listed in rows and each column includes a particular parameter value or operator control associated with one of the available tools. For measurement tools, the columns can include an enable/disable checkbox, a nominal distance value, a tolerance distance value. In certain examples, a contrast level can be set that assists in setting a contrast sensitivity for the measurement tool. In certain examples, the vision inspection system can process the image by looking for light to dark transitions. In certain examples, with respect to the operator interface vision setup tool of FIG. 8, the vision inspection system can process the image by looking for light to dark transitions as the image is processed in the “y” direction. Upon finding two transitions, a measurement can be made for the distance between the transitions.

In certain examples, one or more of the tools can be enabled by clicking and placing a check mark in the “USE” check box. When enabled, evaluation of the tool can be performed and the result can be logically AND'd with other enabled tools to determine whether the imaged part is acceptable or not.

In certain examples, each tool, whether enabled or not, can be named so as to provide a better indication of what particular measurement the tool evaluates.

In certain examples, each row associated with a particular tool can include a screen button that when clicked displays an image with a default operator interface vision setup tool as shown in FIG. 8. The operator can then move, orient and size the setup tool over light to dark transitions that represent a desired measurement. As discussed, setup of the available vision system tools can be accomplished using the HMI environment that also includes operator interface screens for operating the converting machine in production.

In certain examples, an available vision tool can include a histogram tool. A histogram tool can evaluate the shade of a desired area of the image. In certain applications, histogram tools can confirm the presence of a part within the image. In some applications, histogram tools can confirm a particular orientation of a part within the image. In certain examples, each histogram tool available can be enabled or disabled. For evaluation purposes, a nominal shading value can be entered and a tolerance about the nominal value can be evaluated against the actual measured contrast value. In addition to entering the nominal and tolerance values, the operator can activate a default operator interface vision setup tool as shown in FIG. 8, and can then move, orient, and size the setup tool over an area of interest for measuring a contrast level.

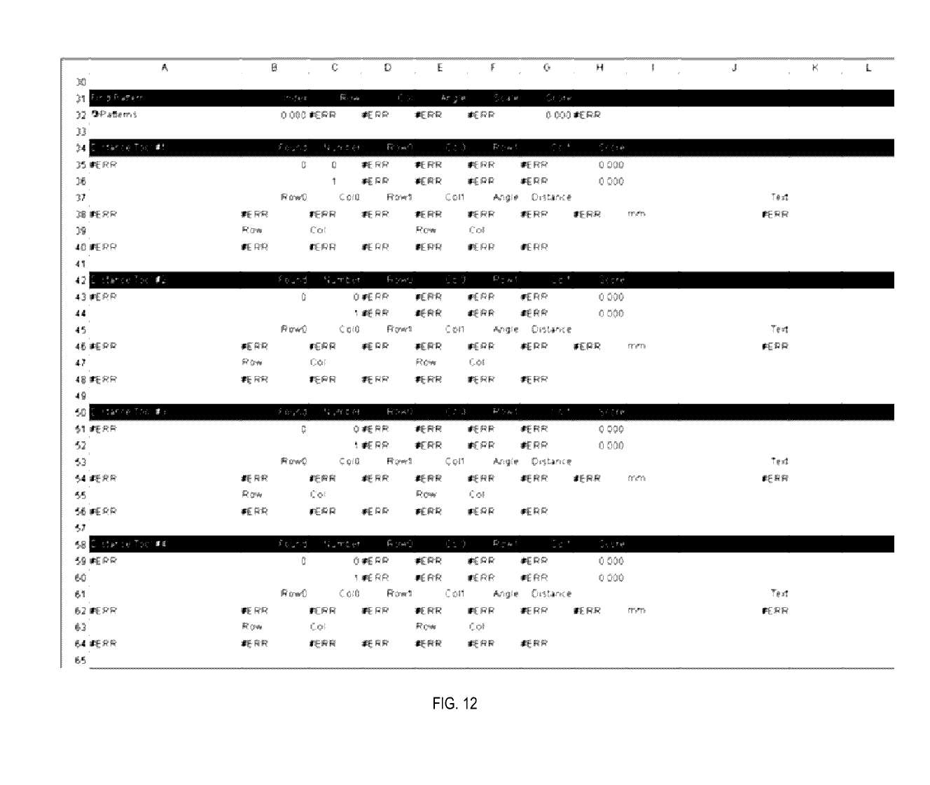

FIG. 10 illustrates generally a flowchart of an example method 1000 for setting up vision system tools using a web converting system HMI environment. At 1002, a first input can be received at the HMI. At 1004, a vision system tool can be displayed over an image of a part configured to be produced on the web converting system in response to the first input. In certain examples, the image of the part can be received from a camera of the vision system configured to capture images of parts as the parts are produced on the web converting system. At 1006, a second input can be received at the HMI. At 1008, a size, position or orientation of the vision system tool can be modified in response to the second input to provide a modified vision system tool. At 1010, a third input can be received at the HMI. At 1012, the modified vision system tool can be saved to the vision system controller in response to the third input at the web converting system HMI. In certain examples, the vision system tool is one of a limited number of vision system tools of the vision system made available for the web converting system operator to modify, such that the operator can modify tools to accommodate changes in a production part or entirely new part configurations for the web converting system to produce. Having the vision system tools available to be modified via the web converting system HMI environment can allow for less machine downtime to accommodate dimensional part changes or new parts.

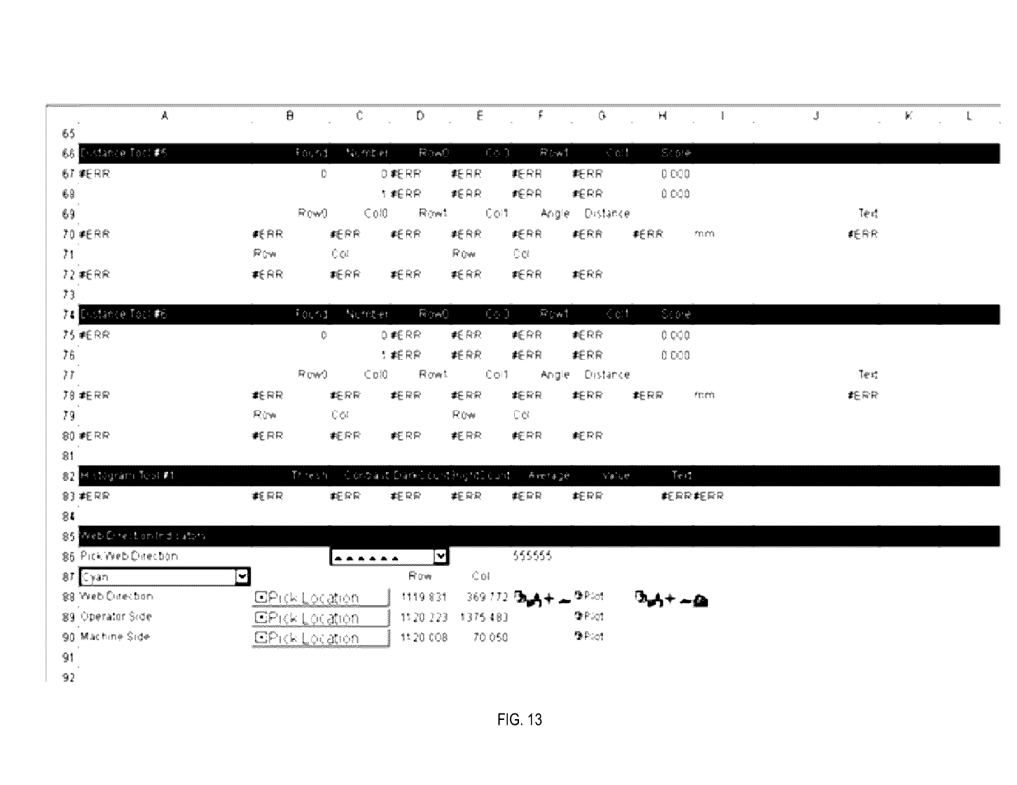

FIGS. 11-13 illustrate generally a programmable tool of an example vision inspection system. In certain examples, a vision technician can populate the example programmable tool with specific vision tools and formulas for receiving measurement information from the vision system for display on the HMI and for receiving information from the operator via the HMI and providing the information to the vision system or the machine controller.

### Notes and Examples

The methods illustrated in this disclosure are not intended to be exclusive of other methods within the scope of the present subject matter. Those of ordinary skill in the art will understand, upon reading and comprehending this disclosure, other methods within the scope of the present subject matter. The above-identified embodiments, and portions of the illustrated embodiments, are not necessarily mutually exclusive. These embodiments, or portions thereof, can be combined. In various embodiments, the methods are implemented using a sequence of instructions which, when executed by one or more processors, cause the processor(s) to perform the respective method. In various embodiments, the methods are implemented as a set of instructions contained on a computer-accessible medium such as a magnetic medium, an electronic medium, or an optical medium.

The above detailed description is intended to be illustrative, and not restrictive. Other embodiments will be apparent to those of skill in the art upon reading and understanding the above description. The scope of the invention should, therefore, be determined with reference to the appended claims, along with the full scope of equivalents to which such claims are entitled.

What is claimed is:

1. A web converting system comprising:
a web converting machine configured to make a first part;
a vision inspection system configured to capture an image of the first part and to analyze the image according to one or more measurement tools;
a human machine interface (HMI) configured to interface with the web converting machine and with the vision inspection system, to display status information of the web converting machine and the vision inspection system, to receive one or more inputs to select, place, size and orient the one or more measurement tools, and to transform the one or more inputs for reception by the vision inspection system.

2. The web converting system of claim 1, wherein the HMI is configured to display an object associated with configuring a vision system, to display a first vision system configuration screen in response to a user input of the object, wherein the first vision system display includes an image of a part configured to be produced by the web converting system and a plurality of partially predefined vision system tools overlaying the image.

3. The web converting system of claim 2, wherein the HMI is configured to receive a first user input at one tool of the plurality of partially defined vision system tools and to display a modifiable image of the tool in relation to the image of the part on the display of the HMI.

4. The web converting system of claim 3, wherein the HMI is configured to receive a second user input signal, to modify the modifiable image of the tool using the second user input and to provide a modified tool using the modified image.

5. The web converting system of claim 4, wherein the HMI is configured to receive run-time images of parts produced on the web converting machine and to display the run time images of the parts with the modified tool and with an indication of whether the tool accepts or rejects the parts.

6. The web converting system of claim 5, wherein the HMI is configured to display a station configuration screen associated with a station of web converting machine, to receive a third user input and to modify a parameter of the station using the third user input.

7. The web converting system of claim 6, wherein the parameter is a station registration parameter.

8. The web converting system of claim 6, wherein the parameter is a station gear ratio parameter.

9. A method for a web converting system, the method comprising:
receiving a first input at a web converting system human machine interface (HMI);
displaying, on a display of the web converting system HMI, a partially predefined vision system tool overlaying an image of a part configured to be produced by the web converting system;
receiving a second input at the web converting system HMI;
modifying one of a size, position or orientation of the partially predefined vision system tool in response to the second input to provide a modified vision system tool;
receiving a third input at the web converting system HMI; and
saving the modified vision system tool at a vision system controller, in response to the third input.

10. The method of claim 9, including:
receiving a fourth input at the web converting HMI;
displaying a station configuration screen on the web converting HMI, the station configuration screen associated with a station of the web converting system;
receiving a fifth input at the web converting HMI; and
modifying a parameter of the station.

11. The method of claim 10, wherein the modifying the parameter includes modifying a registration parameter of the station.

12. The method of claim 10, wherein the modifying the parameter includes modifying a gear ratio parameter of the station.

13. A web converting system comprising:
a web converting machine configured to make a part, the web converting machine including a web inspection station to inspect the part;
a vision inspection system incorporated into the web inspection station and configured to inspect the part as the part is made on the web converting machine, the vision inspection system configured to capture an image of the part and use one or more measurement tools to analyze the image, wherein the vision inspection system is configured to define each measurement tool using a plurality of vision inspection system parameters;
a human machine interface (HMI) configured:
to interface with the web converting machine and the vision inspection system,
to display status information of the web converting machine and the vision inspection system;
to allow modification of parameters of die station associated with the web converting machine;
to provide a measurement tool view to enable a machine operator to select, place, size and orient a distance measurement tool using first HMI vision parameters,
to transform the first HMI vision parameters into at least some of the vision inspection system parameters to modify a first measurement tool of the one or more measurement tools,
to provide the measurement tool view to enable a machine operator to select, place, size and orient a histogram measurement tool using second HMI vision parameters, and
to transform the second HMI vision parameters into at least some of the vision inspection system parameters to modify a second measurement tool of the one or more measurement tools.
